(19) United States
(12) Patent Application Publication
(10) Pub. No.: US 2024/0088570 A1
(43) Pub. Date: Mar. 14, 2024

(54) STRUCTURE AND CONSTRUCTION MATERIAL

(71) Applicant: SEKISUI CHEMICAL CO., LTD., Osaka (JP)

(72) Inventors: Hiroyuki NOMOTO, Osaka (JP); Toshio ENAMI, Osaka (JP)

(73) Assignee: SEKISUI CHEMICAL CO., LTD., Osaka (JP)

(21) Appl. No.: 18/273,125

(22) PCT Filed: Jan. 28, 2022
(86) PCT No.: PCT/JP2022/003319

§ 371 Date: Jul. 19, 2023

(30) Foreign Application Priority Data
Jan. 29, 2021 (JP) 2021-013473

(51) Int. Cl. H01Q 15/14

(52) U.S. Cl. CPC H01Q 15/14

(57) ABSTRACT

Provided are a structure and a building material that are capable of reflecting radio waves over a wide range of space. Provided is a structure comprising a radio wave reflector including a radio wave reflecting material for reflecting radio waves, wherein when the radio wave reflector is caused to reflect a radio wave at an incident angle of an incident wave of 15 degrees or more and 75 degrees or less at a frequency of the incident wave of 3 GHz or more and 5 GHz or less, 25 GHz or more and 30 GHz or less, or 150 GHz or more and 300 GHz or less, the intensity of a reflective wave as specular reflection of the incident wave is −30 dB or more relative to the incident wave, and in a virtual plane including an incident direction of the incident wave and a reflection direction of the reflective wave, when reception angular positions of the reflective wave are varied within an angle range of −15 degrees or more and +15 degrees or less with respect to the specular reflection direction, kurtosis of distribution of intensity of the reflective wave at each of the reception angular positions is −0.4 or less at least at one frequency.

### TECHNICAL FIELD

The present invention relates to a structure and building material for reflecting radio waves.

### BACKGROUND ART

Cellular phones and wireless communications use radio waves in the frequency band of about 3 GHz or more and 300 GHz or less, which are called centimeter waves or millimeter waves. Since such radio waves with a short wavelength have high straight-advancing properties, and circumvention is difficult even in the presence of obstacles, reflectors are used to deliver radio waves over a wide area of space. For example, Patent Literature (PTL) 1 proposes a communication system in which a monopole antenna and a metal reflector for reflecting radio waves are arranged in an underfloor space within a building. In PTL 1, radio waves emitted from the monopole antenna are diffused in the underfloor space while the radio waves are prevented from leaking from the underfloor space to the outside of the living room (the building) or from being absorbed on the floor of the building.

### CITATION LIST

### Patent Literature

PTL 1: JP2010-258514A

### SUMMARY OF INVENTION

### Technical Problem

Metal reflectors for reflecting radio waves are typically composed of a metal plate, such as aluminum or copper. Although metal reflectors reflect radio waves having a short wavelength with high intensity in the specular reflection direction, it is known that they are unlikely to diffusely reflect radio waves. For this reason, delivering radio waves over a wide area of space is difficult with the use of a reflector composed of a metal plate; in order to reduce the space in which radio waves do not reach (blind-spot space), installing a large number of metal reflectors is necessary.

An object of the present invention is to provide a structure and building material for reflecting radio waves over a wide area of space.

### Solution to Problem

To achieve the above object, the present invention encompasses the subject matter described in the following Items.

Item 1. A structure comprising a radio wave reflector including a radio wave reflecting material for reflecting radio waves,

wherein
when the radio wave reflector is caused to reflect a radio wave at an incident angle of an incident wave of 15 degrees or more and 75 degrees or less at a frequency of the incident wave of 3 GHz or more and 5 GHz or less, 25 GHz or more and 30 GHz or less, or 150 GHz or more and 300 GHz or less, the intensity of a reflective wave as specular reflection of the incident wave is −30 dB or more relative to the incident wave, and
in a virtual plane including an incident direction of the incident wave and a reflection direction of the reflective wave, when reception angular positions of the reflective wave are varied within an angle range of −15 degrees or more and +15 degrees or less with respect to the specular reflection direction, kurtosis of distribution of intensity of the reflective wave at each of the reception angular positions is −0.4 or less at least at one frequency.

Item 2. The structure according to Item 1, wherein the kurtosis of distribution of intensity of the reflective wave at each of the reception angular positions is −0.4 or less at a frequency of the incident wave in the range of 3 GHz or more and 300 GHz or less.

Item 3. The structure according to Item 1 or 2, wherein the radio wave reflector includes at least a conductive thin film layer comprising the radio wave reflecting material, and a substrate layer comprising a substrate for holding the conductive thin film layer.

Item 4. The structure according to Item 3, wherein the conductive thin film layer has a developed interfacial area ratio of 0.5% or more and 600% or less.

Item 5. The structure according to Item 3 or 4, wherein the conductive thin film layer has a surface resistance value of 0.3Ω/□ or more and 10Ω/□ or less.

Item 6. The structure according to any one of Items 3 to 5, wherein the radio wave reflecting material of the conductive thin film layer is linear and is arranged to surround regions without the radio wave reflecting material.

Item 7. The structure according to Item 6, wherein the radio wave reflecting material has a line width of 0.05 μm or more and 15 μm or less, a thickness of 0.05 μm or more and 10 μm or less, and a coverage of 50% or less.

Item 8. The structure according to any one of Items 3 to 5, wherein in the conductive thin film layer, a plurality of the radio wave reflecting materials having a sheet shape are periodically arranged.

Item 9. The structure according to Item 8, wherein in the conductive thin film layer, the shortest distance between the adjacent radio wave reflecting materials is 1 mm or less, and the conductive thin film layer has a thickness of 0.010 μm or more and 0.35 μm or less, and a coverage of 5% or more and 99.9% or less.

Item 10. The structure according to any one of Items 1 to 9, wherein the radio wave reflector is transparent.

Item 11. The structure according to any one of Items 1 to 10, wherein in the radio wave reflector, the radio wave reflecting material is laminated with a resin.

Item 12. The structure according to any one of Items 1 to 10, wherein in the radio wave reflector, the radio wave reflecting material is dispersed in a resin.

Item 13. The structure according to any one of Items 1 to 10, wherein in the radio wave reflector, the radio wave reflecting material is held in a sheet shape by a resin.

Item 14. The structure according to any one of Items 1 to 13, wherein the radio wave reflector has flexibility.

Item 15. The structure according to any one of Items 1 to 14, wherein the radio wave reflector has a thickness of 1 mm or less.

Item 16. The structure according to any one of Items 11 to 13, wherein the resin has a dielectric loss tangent of 0.018 or less.

Item 17. The structure according to any one of Items 11 to 13, wherein the resin has a relative permittivity that varies according to an electric field.

Item 18. A building material comprising the structure of any one of Items 1 to 17.

Item 19. The building material according to Item 18, wherein the structure has flexibility and is for use in a curved surface.

Item 20. A building material comprising a radio wave reflector including a radio wave reflecting material for reflecting radio waves,

wherein
when the radio wave reflector is caused to reflect a radio wave at an incident angle of an incident wave of 15 degrees or more and 75 degrees or less at a frequency of the incident wave of 3 GHz or more and 5 GHz or less, 25 GHz or more and 30 GHz or less, or 150 GHz or more and 300 GHz or less, the intensity of a reflective wave as specular reflection of the incident wave is −30 dB or more relative to the incident wave, and
in a virtual plane including an incident direction of the incident wave and a reflection direction of the reflective wave, when reception angular positions of the reflective wave are varied within an angle range of −15 degrees or more and +15 degrees or less with respect to the specular reflection direction, kurtosis of distribution of intensity of the reflective wave at each of the reception angular positions is −0.4 or less at least at one frequency.

### Advantageous Effects of Invention

According to the present invention, radio waves can be reflected over a wide area of space.

### BRIEF DESCRIPTION OF DRAWINGS

FIG. 1 is a diagram for explaining the angle range of reflective wave reflected from a structure according to one embodiment of the present invention.

FIG. 2 is a side view showing the overall schematic configuration of a structure according to one embodiment of the present invention.

FIG. 3 is a plan view showing the overall schematic configuration of the structure shown in FIG. 2.

FIG. 4 is a side view showing the overall schematic configuration of a structure according to another embodiment.

FIG. 5 is a plan view showing the overall schematic configuration of the structure shown in FIG. 4.

FIG. 6 is a cross-sectional view showing the schematic configuration of a structure according to another embodiment, and is a cross-sectional view along the B-B line in FIG. 7(B).

FIG. 7 shows the overall schematic configuration of the radio wave reflector shown in FIG. 6. FIG. 7(A) is a plan view, and (B) is an enlarged plan view of the portion A in (A).

FIGS. 8(A) to (E) are enlarged plan views showing other examples of arrangement patterns of the conductor.

FIG. 9 is a side view showing the overall schematic configuration of a structure according to another embodiment.

FIG. 10 is a cross-sectional view showing the schematic configuration of a structure according to another embodiment.

FIG. 11 is a cross-sectional view showing the schematic configuration of a structure according to another embodiment.

FIG. 12(A) is an explanatory drawing showing an application example of a building material to a building, and (B) is a plan view showing an application example of the building material to the inside of a room.

### DESCRIPTION OF EMBODIMENTS

### Overall Configuration

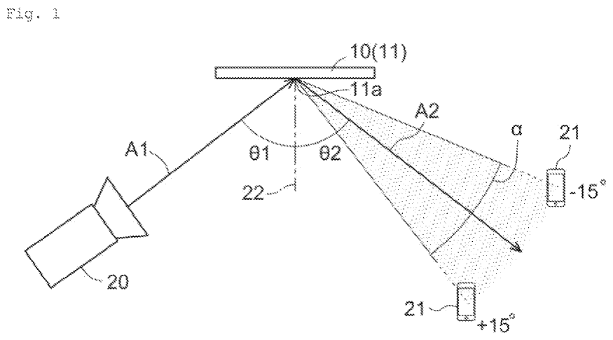

Embodiments of the present invention are described with reference to the drawings. The structure 10 according to this embodiment forms a radio wave reflector 11. As shown in FIG. 1, radio waves output from a radio wave source 20 are reflected. The reflected reflective waves are received by a receiver 21. The radio wave source 20 is, for example, a communication apparatus with a transmitting antenna capable of transmitting radio waves. The receiver 21 is a device capable of receiving radio waves. The receiver 21 according to this embodiment is a communication device with a receiving antenna. Examples of the communication device include smartphones, cellular phones, tablet computing devices, laptop PCs, portable game consoles, repeaters, radios, and televisions.

The radio wave reflector 11 includes a radio wave reflecting material 12 for reflecting radio waves. The radio wave reflector 11 is caused to reflect a radio wave at least at a predetermined incident angle of an incident wave in the range of degrees or more and 75 degrees or less, preferably at all of the angles in the range of 15 degrees or more and 75 degrees or less, at a frequency of the incident wave of 3 GHz or more and 5 GHz or less, 25 GHz or more and 30 GHz or less, or 150 GHz or more and 300 GHz or less. In this case, the intensity of the reflective wave as specular reflection of the incident wave from the radio wave reflector 11 (also referred to below as the “specular reflection intensity”) is −30 dB or more and 0 dB or less relative to the incident wave, and kurtosis (described below) is −0.4 or less at least at one frequency. Preferably, in the entire frequency band of 3 GHz or more and 300 GHz or less, the specular reflection intensity is −30 dB or more and 0 dB or less relative to the incident wave, and the kurtosis is −0.4 or less.

The specular reflection intensity is preferably −25 dB or more and 0 dB or less, more preferably −22 dB or more and 0 dB or less, still more preferably −20 dB or more and 0 dB or less, and even more preferably −15 dB or more and 0 dB or less, relative to the incident wave. When the specular reflection intensity is −30 dB or more relative to the incident wave, the receiver 21 can receive radio waves with an intensity that is practical for use. In this embodiment, the specular reflection intensity and the reflection intensity (described below) are values obtained when the distance between the reflection point 11a of the radio wave reflector 11 and the radio wave source 20, and the distance between the reflection point 11a of the radio wave reflector 11 and the receiver 21, are each set to 1 m.

Referring to FIG. 1, specular reflection means that the incident angle θ1 of an incident wave and the reflection angle θ2 of a reflective wave are equal to each other when a radio wave emitted from the radio wave source 20 (a transmitting antenna) is reflected from the radio wave reflector 11. The reflection direction of the reflective wave as specular reflection of a radio wave is also called the “specular reflection direction.” The incident angle θ1 is an angle formed by an incident wave advancing in the incident direction in which a radio wave is incident on the radio wave reflector 11 (indicated by an arrow A1 in FIG. 1) and a normal line 22 of the reflective surface of the radio wave reflector 11, while the reflection angle θ2 is an angle formed by a reflective wave advancing in the reflection direction of the reflective wave (indicated by an arrow A2 in FIG. 1) and the normal line 22 of the reflective surface. The normal line 22 is a straight line perpendicular to the tangent line (or the tangent plane) at the reflection point 11a.

In the radio wave reflector 11, in a virtual plane including the incident direction of the incident wave and the reflection direction of the reflective wave, the kurtosis of distribution of intensity of the reflective wave at each reception angular position is −0.4 or less when the reception angular positions of the reflective wave are varied within an angle range a of −15 degrees or more and +15 degrees or less with respect to the specular reflection direction of the radio wave. The kurtosis is more preferably −1.0 or less, still more preferably −1.1 or less, and even more preferably −1.2 or less. The lower limit of the kurtosis is not particularly limited and is typically about −5.0. The intensity of the reflective wave at each reception angular position is also referred to below as the “reflection intensity.” The virtual plane can also be referred to as a plane including the reflection point 11a on the reflective surface of the reflector, the radio wave source 20, and the receiver 21 of the reflective wave.

Kurtosis is a statistic that expresses how much a distribution deviates from the normal distribution, and indicates the degree of peakedness and the heaviness of its tail. As shown in FIG. 1, it is assumed that a radio wave output from the radio wave source 20, which is located 1 m away from the reflection point 11a, is incident on the radio wave reflector 11 at a predetermined incident angle θ1. Then, a reflection intensity x is measured by moving a reception angular position i of the receiver 21 by a predetermined angle each (e.g., 5 degrees each) from the specular reflection direction of the radio wave with the reflection point 11a being set as the center, within the angle range a of −15 degrees or more and +15 degrees or less with respect to the specular reflection direction of the radio wave. The reception angular position i of the receiver 21 is located on an arc having a radius of 1 m from the reflection point 11a set as the center. The kurtosis is calculated according to the following formula when the average value of the values of the reflection intensity at each reception angular position i
xᵢ(i: 1, 2, . . . , n)
is
x̅, and
the standard deviation is s.

$$Kurtosis = \frac{n ( n + 1 )}{( n - 1 ) ( n - 2 ) ( n - 3 )} {\sum }_{i = 1}^{n} \frac{{( {x}_{i} - \overline{x} )}^{4}}{{S}^{4}} - \frac{3 {( n - 1 )}^{2}}{( n - 2 ) ( n - 3 )} \qquad Formula 1$$

Negative kurtosis values indicate that the distribution of intensity data in terms of each angular position is flatter than the normal distribution; i.e., the data values spread from around the mean value and the tail of the distribution is wider. The smaller the kurtosis value, the flatter the distribution. In this embodiment, the kurtosis is set to −0.4 or less; thus, the difference in the reflection intensity between the reception angular positions is made small within the angle range a of ±15 degrees with respect to the specular reflection direction of a radio wave. The kurtosis can be adjusted according to, for example, the resin type and structure of resin layers (a substrate layer 13, an adhesive layer 14, and a protective layer described below) constituting the radio wave reflector 11, and according to the developed interfacial area ratio Sdr.

The radio wave reflector 11 as a whole may have visible-light transmission properties, i.e., it may be transparent. The substrate layer 13, the adhesive layer 14, and the protective layer 15 described below may each be formed with a resin that has visible-light transmission properties, and the radio wave reflecting material 12 of the conductive thin film layer 16 may be formed to have such a thickness as to exhibit visible-light transmission properties. The term “transparent” used here means that one side of the radio wave reflector 11 is visible when viewed from the other side, includes translucent, and is not limited to completely transparent, in which the total light transmittance is 100%. Further, the radio wave reflector 11 may be colored. For standard illuminant D65, the radio wave reflector 11 has a total light transmittance of 65% or more, preferably 80% or more, still more preferably 85% or more, and even more preferably 90% or more. The total light transmittance is a ratio of the total transmitted luminous flux to the parallel incident luminous flux of a test piece and is measured in accordance with JIS K 7375:2008.

As shown in FIG. 3, in this embodiment, the overall shape of the radio wave reflector 11 is a square in plan view, and the one-side length L10 is preferably 20 cm or more and 400 cm or less. Since radio waves having a frequency of 3 GHz or more and 300 GHz or less are attenuated by distance, the one-side length L10 is preferably set to 20 cm or more in order to achieve reflection with sufficient intensity at all points within the practical distance from the radio wave source 20. The upper limit of the one-side length L10 is not particularly limited; from a manufacturing standpoint, the upper limit is preferably 400 cm or less. The overall shape of the radio wave reflector 11 is not limited to a square and may be a rectangle or a polygon, such as a triangle, pentagon, or hexagon. In this case, the length of the shortest side is set to 20 cm or more and 400 cm or less. Alternatively, the shortest distance between one vertex and the opposite side or between one side and the opposite side may be set to 20 cm or more and 400 cm or less. If the overall shape of the radio wave reflector 11 is circular, the diameter is set to 20 cm or more and 400 cm or less. If the overall shape of the radio wave reflector 11 is elliptical, the short diameter is set to 20 cm or more and 400 cm or less. If the overall shape of the radio wave reflector 11 is sector, the length of the arc or radius, whichever is shorter, is set to 20 cm or more and 400 cm or less. The overall shape of the radio wave reflector 11 may also be cylindrical, conical, or other three-dimensional shapes. The radio wave reflector 11 has an overall shape and size that enable reflection of radio waves with a reflection intensity of −30 dB or more relative to the incident wave, and the shape and size are appropriately selected according to embodiments in which the radio wave reflector 11 is used.

In this embodiment, the radio wave reflector 11 has a thickness L11 of about 0.5 mm. The thickness L11 is not limited to this value and is preferably 1 mm or less. The thicknesses of the substrate layer 13, the radio wave reflecting material 12 of the conductive thin film layer 16, the adhesive layer 14, and the protective layer 15, described below, are set such that the thickness L11 of the radio wave reflector 11 is 1 mm or less. Since the thickness L11 of the radio wave reflector 11 is small, the radio wave reflecting material 12 has flexibility. Flexibility refers to the property of being flexible under ordinary temperature and ordinary pressure, and capable of undergoing deformation, such as bending, curving, or folding, without shearing or rupture even when force is applied. In this embodiment, the radio wave reflector 11 has flexibility to the extent that it can be bonded along a curved surface with a curvature radius R of about 300 mm; however, the value of the curvature radius R is not limited. The thickness L11 of the radio wave reflector 11 is the sum of the thickness L3 of the conductive thin film layer 16, the thickness L8 of the substrate layer 13, the thickness L4 of the adhesive layer 14, and the thickness L5 of the protective layer 15. However, since the thickness L3 of the conductive thin film layer 16 is very thin compared to each of the thicknesses L8, L4, and L5 of the substrate layer 13, the adhesive layer 14, and the protective layer 15, the thickness L3 of the conductive thin film layer 16 may be ignored when calculating the thickness L11 of the radio wave reflector 11.

The thickness L11 of the radio wave reflector 11, the thickness L3 of the conductive thin film layer 16, the thickness L8 of the substrate layer 13, the thickness L4 of the adhesive layer 14, and the thickness L5 of the protective layer 15 are each determined by measuring any multiple points and calculating the average value of the obtained measurement values. The thickness L11, thickness L3, thickness L8, thickness L4, and thickness L5 may be measured, for example, by a reflectance spectroscopic film thickness analyzer (e.g., F3-CS-NIR produced by Filmetrics Japan, Inc.) as a measuring instrument.

The Applicant has found that at a predetermined incident angle θ1 of an incident wave in the range of 15 degrees or more and 75 degrees or less, preferably at all of the angles in the range of 15 degrees or more and 75 degrees or less, the receiver 21 can receive a radio wave reflected from the radio wave reflector 11 in a wide area of space by setting both the specular reflection intensity and the kurtosis within the angle range a of ±15 degrees to values within the predetermined ranges as described above. Therefore, even with the use of short-wavelength radio waves with high straight-advancing properties, it is possible to reduce the blind-spot space in the interior as much as possible.

### Configuration of Structure 10

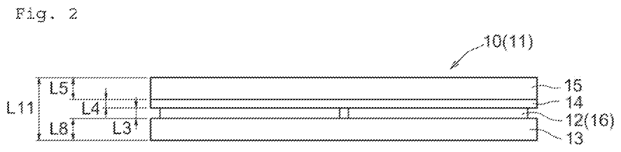

The radio wave reflector 11, which is a structure 10, according to one embodiment is explained with reference to FIGS. 2 and 3. The radio wave reflector 11 has, for example, a metamaterial structure. In the metamaterial structure, the radio wave reflecting materials 12 as dielectrics are arranged periodically at equal intervals. Due to this periodic arrangement structure, the reflector has a negative permittivity, and reflects radio waves in a specific frequency band that is determined based on the periodic interval. The radio wave reflector 11 includes a conductive thin film layer 16, which comprises the radio wave reflecting material 12, and a resin for holding the radio wave reflecting material 12 in a sheet shape. The resin may comprise a substrate layer 13 comprising a substrate, a protective layer 15 comprising a protective material for protecting the conductive thin film layer 16, and an adhesive layer 14 comprising an adhesive material for bonding the conductive thin film layer 16 and the protective layer 15. In the embodiment shown in FIG. 2, in the radio wave reflector 11, the conductive thin film layer 16 is laminated on the substrate layer 13; and on the conductive thin film layer 16, the adhesive layer 14 and the protective layer 15 are laminated sequentially.

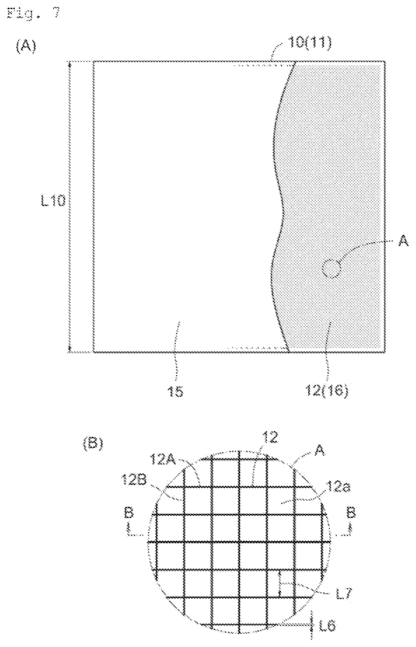

In the following explanations, the up-down direction is defined based on FIGS. 2 and 6, and the vertical-horizontal direction is defined based on FIGS. 3 and 7; however, the up-down direction and vertical-horizontal direction are used for illustrative purposes and do not define the up-down direction and vertical-horizontal direction at the time of use, such as installation of the structure 10 in a building. Further, FIGS. 1 to 12 are not drawn to actual scale. Additionally, in FIG. 7(A), the adhesive layer 14 and the protective layer 15 are omitted in part of the radio wave reflector 11.

### Substrate Layer 13

In this embodiment, the outer shape of the substrate layer 13 is a square in plan view. The shape is not limited to this and may be rectangular, circular, oval, sector, polygonal, three-dimensional, etc. according to the overall shape of the radio wave reflector 11. The substrate of the substrate layer 13 may be a sheet of a synthetic resin. Examples of synthetic resins include one or more members selected from the group consisting of PET (polyethylene terephthalate), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin. Although the thickness L8 of the substrate layer 13 (the length in the up-down direction in FIG. 2) is set to 50 μm in this embodiment, the thickness is not limited to this value and is set appropriately according to embodiments in which the structure 10 is used. In addition to the substrate, the substrate layer 13 may comprise any substance such as a synthetic resin, and any component.

### Conductive Thin Film Layer 16

In one example, the conductive thin film layer 16 is obtained by forming the radio wave reflecting material 12 into a thin film having a square sheet shape on the upper surface of the substrate layer 13. The radio wave reflecting material 12 is preferably composed of, for example, silver (Ag). However, the radio wave reflecting material 12 may be composed of any metal, metal compound, or alloy that has free electrons. Examples include not only silver, but also gold, copper, platinum, aluminum, titanium, silicon, indium tin oxide, and alloys (e.g., alloys containing nickel, chromium, and molybdenum). Examples of alloys containing nickel, chromium, and molybdenum include various grades of alloys, such as Hastelloy B-2, B-3, C-4, C-2000, C-22, C-276, G-30, N, W, and X. Sheet shape means a shape in which the length in the longitudinal direction is substantially the same as or less than 3000 times the length in the direction perpendicular to the longitudinal direction.

In one example, as shown in FIG. 3, the wave reflecting materials 12 each have a square shape in plan view, and the one-side length L1 and the shortest distance (interval) L2 between the adjacent radio wave reflecting materials 12 are set according to the frequency band of a radio wave to be reflected. In this embodiment, radio waves with a frequency of 20 GHz or more and 300 GHz or less, which is the frequency band used in, in particular, the fifth-generation mobile communication system (5G), are reflected. For example, the one-side length L1 is set to 77.460 mm, and the interval L2 between the adjacent radio wave reflecting materials 12 is set to 100 μm. However, the length L1 and the interval L2 are not limited to these values and may be set such that the radio wave reflecting material 12 reflects radio waves with a frequency of 3 GHz or more and 300 GHz or less. In this case, the one-side length L1 of the radio wave reflecting material 12 may be 0.7 mm or more and 800 mm or less, and the interval L2 may be 1 μm or more and 1000 μm or less. In this embodiment, as shown in FIG. 3, four radio wave reflecting materials 12 in total are formed on the substrate layer 13, i.e., two vertically and two horizontally, according to the size of the substrate layer 13. However, the number of the radio wave reflecting materials 12 is appropriately set according to the size (area) of the substrate layer 13.

The thickness (film thickness) L3 of the radio wave reflecting material 12 is preferably a thickness that is sufficient to exhibit visible-light transmission properties. The thickness L3 of the radio wave reflecting material 12 is preferably 350 nm (0.35 μm) or less, more preferably 100 nm or less, and still more preferably 50 nm or less. The thickness L3 is preferably 5 nm or more from the viewpoint of ensuring appropriate radio wave intensity.

The conductive thin film layer 16 preferably has a surface resistance value of 0.3 WO or more and 10Ω/□ or less, and more preferably 3.5Ω/□ or less. The surface resistance value of the conductive thin film layer 16 is specifically the surface resistance value of the radio wave reflector 11.

The surface resistance value can be measured in accordance with the four-terminal method specified in JIS K 7194:1994 by bringing measurement terminals into contact with the surface of the conductive thin film layer. If the conductive thin film layer 16 is protected with a resin sheet etc. and is not exposed, the measurement may be performed by an eddy current method using a non-contact resistance measurement instrument (product name: EC-80P or an equivalent thereof, produced by Napson Corporation).

The developed interfacial area ratio Sdr of the conductive thin film layer 16 is not particularly limited and is preferably 0.05% or more and 600% or less, more preferably 1% or more and 580% or less, still more preferably 2% or more and 180% or less, and even more preferably 3% or more and 90% or less. A developed interfacial area ratio Sdr within this range makes it easier to adjust the specular reflection intensity and kurtosis to be within the ranges described above. As a result, radio waves are more likely to be diffusely reflected.

The calculation formula for the developed interfacial area ratio Sdr is given in JIS B-0681-2:2018, and the measurement is performed in accordance with JIS B-0681-6:2014. By using a laser microscope (product name: VK-X1000/1050, produced by Keyence Corporation, or an equivalent thereof), the developed interfacial area ratio Sdr of the radio wave reflecting material 12 can be determined by measuring the height at multiple points on the surface of the conductive thin film layer 16 (the radio wave reflecting material 12), and calculating the developed area from the resulting measurement values. In this embodiment, the conductive thin film layer 16 comprises a plurality of the radio wave reflecting materials 12 in a sheet shape; thus, the height in the radio wave reflecting materials 12 is measured at multiple points in each of the radio wave reflecting materials 12, and using the obtained measurement values, the developed interfacial area ratios Sdr are each calculated. Thereafter, the arithmetic mean value is calculated to determine the developed interfacial area ratio Sdr of the conductive thin film layer 16.

The conductive thin film layer 16 preferably has a coverage of 5% or more and 99.9% or less. Coverage refers to the percentage of area occupied by the radio wave reflecting material 12 per unit area in plan view. In the embodiment shown in FIGS. 2 and 3, the coverage refers to the percentage of the area of the radio wave reflecting materials 12 in plan view in the area of the substrate layer 13 in plan view. The coverage can also refer to the area of the substrate layer 13 covered by the radio wave reflecting material 12 with respect to the area of the substrate layer 13 in plan view. The coverage is measured using, for example, a scanning electron microscope (SEM), transmission electron microscope (TEM), or optical microscope.

The shape of the radio wave reflecting material 12 is not limited to a square and may be any shape. The shape is preferably such that an arrangement is possible in which a side of one radio wave reflecting material 12 and a side of adjacent radio wave reflecting materials 12 are parallel while the intervals between one radio wave reflecting material 12 and all of adjacent radio wave reflecting materials 12 are equal. For example, the shape may be a rectangle, triangle, or hexagon. The number of the radio wave reflecting materials 12 formed on the substrate layer 13 is set according to the size (area) of the radio wave reflector 11.

### Another Embodiment of Conductive Thin Film Layer 16

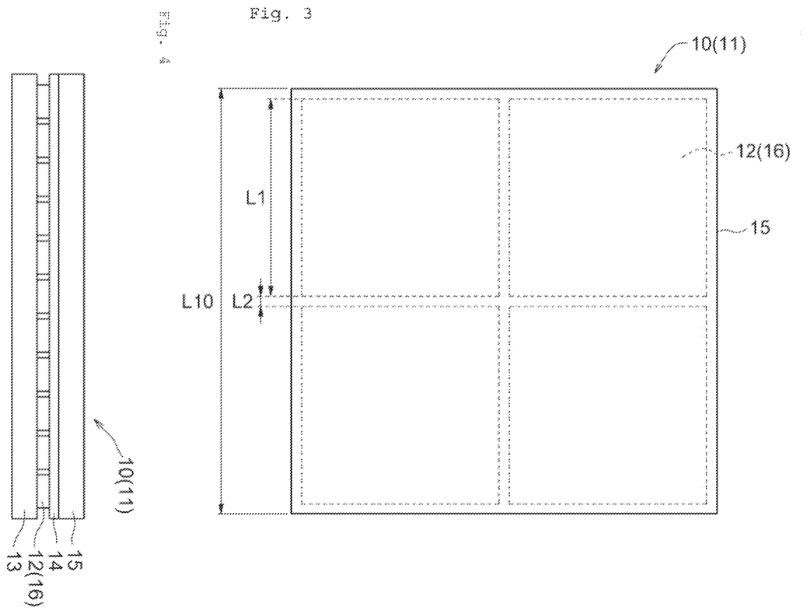

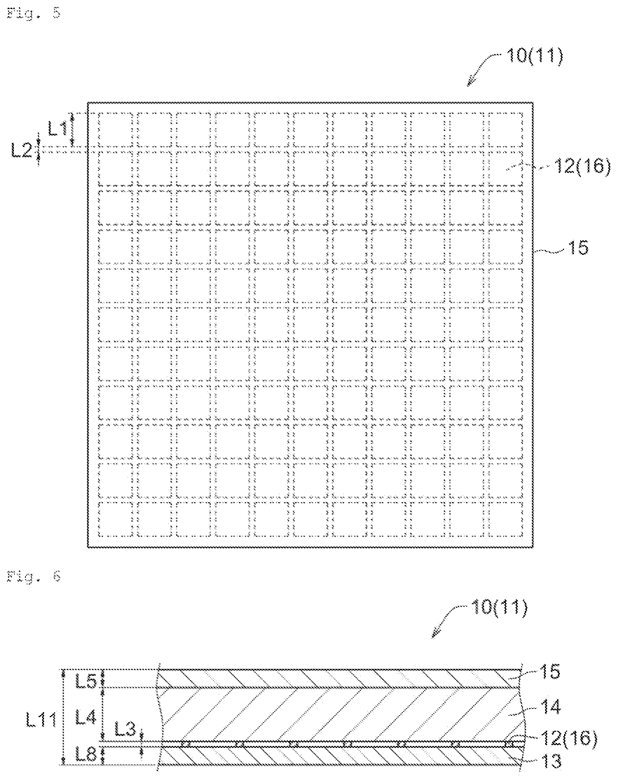

FIGS. 4 and 5 show another embodiment of the radio wave reflecting material 12, which is the conductive thin film layer 16. The embodiment shown in FIGS. 4 and 5 differ from the embodiment shown in FIGS. 2 and 3 in the size and number of the radio wave reflecting materials 12. In the radio wave reflecting material 12 according to this embodiment, the one-side length L1 and the interval L2 between the adjacent radio wave reflecting materials 12 are set so as to reflect radio waves, in particular, in the frequency band of 3 GHz or more and 10 GHz or less used in wireless LAN (Wi-Fi (registered trademark)) and in the sixth-generation mobile communication system (6G) or subsequent generations of mobile communication systems. In this embodiment, the one-side length L1 is set shorter than that of the embodiment shown in FIGS. 2 and 3. For example, the one-side length L1 is set to 7.7460 mm. However, the one-side length L1 is not limited to this value and may be 0.7 mm or more and 800 mm or less, and the interval L2 may be 1 μm or more and 1000 μm or less.

In this embodiment, the substrate layer 13 is set to have the same size as the substrate layer 13 in the embodiment shown in FIGS. 2 and 3. As shown in FIG. 5, 121 radio wave reflecting materials 12 in total, i.e., 11 vertically and 11 horizontally, are formed on the substrate layer 13. However, the number of the radio wave reflecting materials 12 is appropriately set according to the size of the substrate layer 13. Other configurations of the conductive thin film layer 16 are the same as those in the embodiment shown in FIGS. 2 and 3.

In this embodiment, since the periodic interval between the periodically arranged radio wave reflecting materials 12 is small, radio waves with a frequency of 3 GHz or more and 10 GHz or less, which is the frequency band according to this periodic interval, can be reflected within a wide angle range a. Other configurations and functions are the same as those in the embodiment shown in FIGS. 2 and 3, and the same reference numerals are used to refer to corresponding configurations to omit the detailed descriptions thereof.

### Another Embodiment of Conductive Thin Film Layer 16

FIGS. 6 and 7 show another embodiment of the radio wave reflective material 12, which is a conductive thin film layer 16. In the example shown in FIGS. 6 and 7, in the conductive thin film layer 16, one or a plurality of linear radio wave reflecting materials 12 are arranged to surround multiple regions 12a without the radio wave reflecting material 12. That is, the radio wave reflecting materials 12 and the regions 12a without the radio wave reflecting material 12 are periodically arranged at predetermined intervals. The interval between the adjacent regions 12a without the radio wave reflecting material 12 may be a length equal to or greater than the line width L6 of the radio wave reflecting material 12. Linear means that the length in the longitudinal direction is at least 3,000 times longer than the length in the direction perpendicular to the longitudinal direction. In the example shown in FIG. 7(B), the radio wave reflecting materials 12 are arranged at equal intervals along the vertical direction and the horizontal direction, and the region 12a without the radio wave reflecting material 12 surrounded by the radio wave reflecting materials 12 is a square. That is, the regions 12a without the radio wave reflecting material 12 are arranged at an interval that is equal to the line width L6 of the radio wave reflecting material 12. At the intersections at which the radio wave reflecting material 12 (12A) along the horizontal direction and the radio wave reflecting material 12 (12B) along the vertical direction overlap, the radio wave reflecting materials 12A and 12B are electrically conducting. The line width L6 of the radio wave reflecting material 12 is preferably set to 0.05 μm or more and 15 μm or less. The length L7 between the adjacent radio wave reflecting materials 12 along the vertical direction or the horizontal direction (the one-side length of the square region 12a without the radio wave reflecting materials 12) is set to be sufficiently larger than the wavelengths of visible light and smaller than the wavelengths of the radio waves reflected from the radio wave reflector 11. In this example, the length L7 is set to 2 μm or more and 10 cm or less. The length L7 is more preferably 20 μm or more and 1 cm or less, still more preferably 25 μm or more and 1 mm or less, and even more preferably 30 μm or more and 250 μm or less. The thickness L3 of the radio wave reflecting material 12 is preferably 0.05 μm or more and 10 μm or less. In this embodiment, the coverage of the conductive thin film layer 16 is preferably 50% or less and preferably 1% or more, and more preferably 10% or less. In this embodiment, the surface resistance value of the conductive thin film layer 16 is preferably 0.3Ω/□ or more and 10Ω/□ or less.

The preferred range, calculation formula, and measurement method for the developed interfacial area ratio Sdr of the conductive thin film layer 16 are the same as those in the embodiment shown in FIGS. 2 and 3. In this embodiment, the conductive thin film layer 16 includes a plurality of the linear radio wave reflecting materials 12. The height is measured at multiple points in the conductive thin film layer 16, and using the obtained measurement values, the developed interfacial area ratios Sdr are each calculated. Thereafter, the arithmetic mean value is calculated to determine the developed interfacial area ratio Sdr of the conductive thin film layer 16.

Other configurations of the conductive thin film layer 16 are the same as those in the embodiment shown in FIGS. 2 and 3.

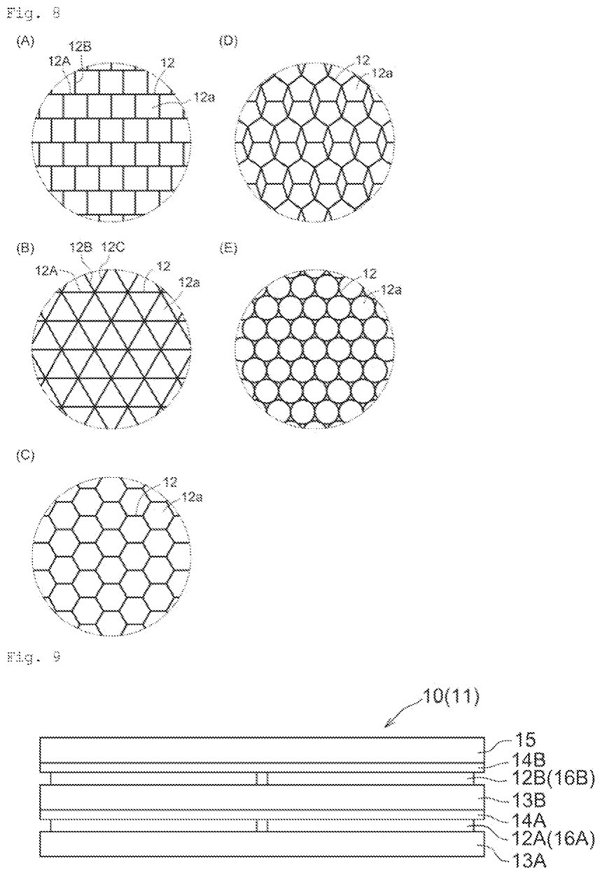

In the arrangement of the radio wave reflecting materials 12 shown in FIG. 7(B), the shape of the region 12a without the radio wave reflecting material 12 is a square. Alternatively, for example, the interval between the adjacent radio wave reflecting materials 12A extending in the horizontal direction may be different from the interval between the adjacent radio wave reflecting materials 12B extending in the vertical direction, and the shape of the region 12A without the radio wave reflecting material 12 may be rectangular. It is also possible to arrange the radio wave reflecting materials 12 according to the arrangement patterns shown in FIG. 8(A) to (E). In FIG. 8(A), a plurality of the radio wave reflecting materials 12A extending in the horizontal direction are arranged in the vertical direction at predetermined intervals, and a plurality of the radio wave reflecting materials 12B extending in the vertical direction are arranged in a staggered manner between the radio wave reflecting materials 12A, which are adjacent to each other in the vertical direction. Staggered means a state in which a plurality of the radio wave reflecting materials 12B extending in the vertical direction are arranged at predetermined intervals in the horizontal direction, and a plurality of the radio wave reflecting materials 12B forming a single row are positioned between a plurality of the radio wave reflecting materials 12B forming rows that are adjacent in the vertical direction to the row, whereby the radio wave reflecting materials 12B forming rows alternately are arranged in a straight line. In FIG. 8(B), the radio wave reflecting materials 12A extend in the horizontal direction, the radio wave reflecting materials 12B and 12C extend along oblique directions symmetrically inclined with respect to the horizontal direction, and the radio wave reflecting materials 12B and 12C intersect with each other on the radio wave reflecting materials 12A. Accordingly, the shape of the region 12a without the radio wave reflecting material 12 is an equilateral triangle. Instead of an equilateral triangle, the shape of the region 12a without the radio wave reflecting material 12 may be an isosceles triangle or a triangle having three sides of different lengths. In FIG. 8(C), the regions 12a without the radio wave reflecting material 12 surrounded by the linear radio wave reflecting materials 12 and having a regular hexagonal shape are periodically arranged. In FIG. 8(D), the regions 12a without the radio wave reflecting material 12 surrounded by the linear radio wave reflecting materials 12 and having a regular pentagonal shape are periodically arranged. In FIG. 8(E), the regions 12a without the radio wave reflecting material 12 surrounded by the linear radio wave reflecting materials 12 and having a circular shape are periodically arranged. FIGS. 8(A) to 8(E) show only the radio wave reflecting materials 12.

Examples of the method for producing the conductive thin film layers 16 having the arrangement patterns shown in FIGS. 6 to 8 include a method comprising forming a conductive film, forming a pattern by etching, and taking out a conductive thin film body having the pattern; and a method comprising applying a photosensitive resist to a base film having a lift-off layer, forming a pattern by a photolithography method, filling the pattern portion with a conductor, and then taking out a conductive thin film body having the pattern. The method for producing the conductive thin film layer 16 is not limited to the above methods, and examples include a method of bonding a metal thin film and a method of depositing a metal.

### Adhesive Layer 14

The adhesive layer 14 is configured to adhere the protective layer 15 on the substrate layer 13 and the conductive thin film layer 16, and is composed of an adhesive material. The adhesive layer 14 has a size corresponding to the substrate layer 13 in plan view. The adhesive material of the adhesive layer 14 for use may be a synthetic resin or a rubber adhesive sheet. Examples of synthetic resins include an acrylic resin, a silicon resin, and a polyvinyl alcohol resin. The thickness L4 of the adhesive layer 14 is set to 150 μm in this embodiment, but is not limited to this value and is set to 5 μm or more and 500 μm or less. In addition to the adhesive material, the adhesive layer 14 may comprise any substance such as a synthetic resin, and any component.

The adhesive layer 14 preferably comprises a synthetic resin material having a dielectric loss tangent (tan 6) of 0.018 or less. The lower the dielectric loss tangent, the more preferable it is. The dielectric loss tangent is typically 0.0001 or more. The dielectric loss tangent represents the degree of electrical energy loss in a dielectric. The electrical energy loss is greater in a material having a greater dielectric loss tangent. The use of the adhesive layer 14 having a dielectric loss tangent of 0.018 or less can reduce the loss of electrical energy of radio waves in the radio wave reflector 11, and can further increase the reflection intensity.

The synthetic resin material of the adhesive layer 14 preferably has a relative permittivity that varies according to the frequency of an electric field. The relative permittivity is a ratio of the permittivity in a medium (the synthetic resin material in this embodiment) to the permittivity in the vacuum. Since the relative permittivity varies according to an electric field, the intensity of the reflective wave can be increased in an electric field at a specific frequency. The relative permittivity at a frequency of 10 GHz preferably varies between 1.5 or more and 7 or less, and more preferably between 1.8 or more and 6.5 or less. The dielectric loss tangent and the relative permittivity are measured by a known method (e.g., a cavity resonator method or a coaxial resonator method) using a measuring instrument (e.g., TOYO Corporation, model number: TTPX table-top cryogenic probe station or an MIA-5M material/impedance analyzer).

Not only the synthetic resin material constituting the adhesive layer 14, but also the synthetic resin material constituting the substrate layer 13 and the protective layer 15, may have a dielectric loss tangent of 0.018 or less, and may have a relative permittivity that varies according to an electric field.

### Protective Layer 15

The protective layer 15 has a size corresponding to the substrate layer 13 in plan view, protects the radio wave reflecting material 12, and is composed of a protective material. The protective material of the protective layer 15 for use may be a sheet (film) of a synthetic resin. Examples of synthetic resins include one or more members selected from the group consisting of PET (polyethylene terephthalate), COP (cycloolefin polymer), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin. The thickness L5 of the protective layer 15 is set to 50 μm in this embodiment, but is not limited to this value and is set to 20 μm or more and 1000 μm or less. In addition to the protective material, the protective layer 15 may comprise any substance such as a synthetic resin, and any component.

According to this embodiment, when a radio wave is incident at a predetermined incident angle of incident wave of 15 degrees or more and 75 degrees or less, it is possible to reflect the radio wave within a wide angle range a of ±15 degrees with respect to the reflective wave as specular reflection of the incident radio wave while the reflection intensity is kept high, making it possible to deliver the radio wave to a wide area of space. Accordingly, there is no need to install a large number of reflectors to reduce the blind-spot space, unlike conventional reflectors composed of a metal plate.

Further, in the embodiment shown in FIGS. 2 and 3, the frequency of the radio wave reflected from the radio wave reflector 11 is determined by setting the one-side length L1 of the radio wave reflecting material 12 and the interval L2 between the adjacent radio wave reflecting materials 12. By setting the one-side length L1 and the interval L2, it is possible to reflect radio waves with a frequency of 20 GHz or more and 300 GHz or less, which is the frequency band used in the fifth-generation mobile communication system (5G), over a wide area of space.

Further, since the structure 10, which is the radio wave reflector 11, is transparent, when the structure 10 is provided in a room of a building, blocking or obstructing the scenery of the interior etc. can be prevented.

Further, since the radio wave reflector 11 is held in a sheet shape by a resin, the metamaterial structure in which fine radio wave reflectors 11 are periodically arranged can be maintained.

Furthermore, since the thickness L11 of the entire structure 10, which is the radio wave reflector 11, is as thin as 1 mm or less, the structure 10 is likely to have flexibility and can be attached to a curved surface.

Moreover, the use of a resin having a dielectric loss tangent of 0.018 or less can reduce the loss of electric energy of radio waves in the structure 10, and the intensity of reflective waves can be further increased. In addition, since the relative permittivity of the resin varies according to an electric field, the intensity of the reflective waves can be further increased in an electric field at a specific frequency.

### Another Embodiment

FIG. 9 shows another embodiment of the present invention. The structure 10, which is the radio wave reflector 11, shown in FIG. 9 is a laminated body in which two layers, i.e., the conductive thin film layers 16A and 16B respectively comprising the radio wave reflecting materials 12A and 12B, are laminated in the up-down direction with the substrate layers 13A and 13B, which are resins. In the lamination, the radio wave reflecting materials 12A formed on the substrate layer 13A and the radio wave reflecting materials 12B formed on the substrate layer 13B are aligned to overlap each other in plan view. Alternatively, the arrangement patterns of the conductive thin film layers 16A and 16B shown in FIG. 9 may not overlap each other in plan view, and the conductive thin film layers 16A and 16B may have different arrangement patterns. The lower surface of the substrate layer 13B is bonded to the radio wave reflecting material 12A via the adhesive layer 14A, and the protective layer is bonded to the radio wave reflecting material 12B via the adhesive layer 14B.

While radio waves incident on the radio wave reflector 11 are reflected from the radio wave reflecting material 12B of the first layer, part of the radio waves pass through the radio wave reflecting material 12B without being reflected from the radio wave reflecting material 12B. The radio waves that passed through the radio wave reflecting material 12B are reflected from the radio wave reflecting material 12A of the second layer. Accordingly, by laminating a plurality of the radio wave reflecting materials 12 in the up-down direction, radio waves that passed through the radio wave reflecting material 12B of the upper layer can be reflected from the radio wave reflecting material 12A of the lower layer, and the reflection intensity of the radio wave reflector 11 can be kept higher compared with the case where the radio wave reflecting material 12 comprises only a single layer. In addition, the kurtosis of distribution of the reflection intensities within the angle range a of ±15 degrees with respect to the specular reflection direction of radio waves can be further reduced, making the difference in the reflection intensity between the angular positions within the angle range a small. Further, the use of the two adhesive layers 14A and 14B can further reduce the value of the dielectric loss tangent as compared with the embodiments shown in FIGS. 2 to 8, making it possible to keep the reflection intensity higher. Other configurations and functions are the same as those in the embodiment shown in FIGS. 2 and 3, and the same reference numerals are used to refer to corresponding configurations to omit the detailed descriptions thereof.

In the embodiment shown in FIG. 9, two layers of the radio wave reflecting materials 12 formed on the respective substrate layers 13 are laminated. Alternatively, three layers or more thereof may be laminated. As the number of the layers of the radio wave reflecting materials 12 increases, the reflection intensity increases; however, since the overall thickness of the radio wave reflector 11 increases, the flexibility decreases, and the visible-light transmission properties also decrease. For this reason, the number of the layers is set appropriately according to the intended use etc.; for example, the number of the layers is increased, in particular, when the structure 10 is installed at a location that does not require flexibility and transparency.

In the embodiment shown in FIG. 9, the developed interfacial area ratio Sdr may be determined for each of the radio wave reflecting materials 12A and 12B, and the arithmetic mean value of the obtained developed interfacial area ratios Sdr may be defined as the developed interfacial area ratio Sdr of the conductive thin film layers 16A and 16B. The preferred range, calculation formula, and measurement method for the developed interfacial area ratio Sdr are the same as those in the embodiment shown in FIGS. 2 and 3.

### Another Embodiment

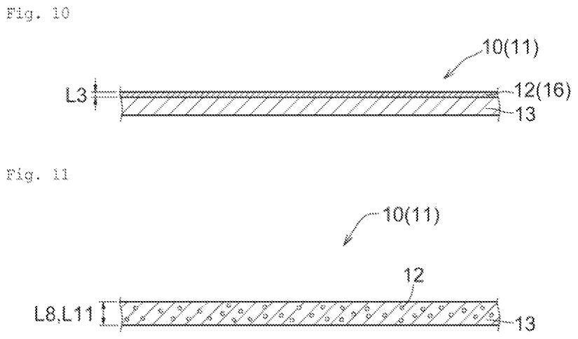

FIG. 10 shows another embodiment of the radio wave reflector 11. In the embodiment shown in FIG. 10, the structure 10, which is the radio wave reflector 11, comprises a conductive thin film layer 16 and a substrate layer 13, but does not comprise an adhesive layer 14 and a protective layer 15. The radio wave reflecting material 12 of the conductive thin film layer 16 here is formed in a square shape as a thin film having a sheet shape on substantially the entire upper surface of the substrate layer 13. The thickness L3 of the radio wave reflecting material 12 is set to 10 nm in this embodiment but is not limited to this value. The surface resistance value in this embodiment is 9.8 WO. In the embodiment shown in FIG. 10, the coverage is defined as the percentage of the area occupied by the radio wave reflecting material 12 per unit area in the portion at which the conductive thin film layer 16 is provided on the substrate layer 13, and the coverage is 100%. In this embodiment, the total light transmittance of the radio wave reflector 11 is 70%. Other configurations and functions are the same as those in the embodiment shown in FIGS. 2 and 3, and the same reference numerals are used to refer to corresponding configurations to omit the detailed descriptions thereof. Alternatively, the size of the radio wave reflecting material 12 may be slightly smaller than the size of the substrate layer 13 in plan view such that the radio wave reflecting material 12 is not formed in the region close to the side edges of the substrate layer 13.

In this embodiment, the conductive thin film layer 16 is composed of a single sheet of the radio wave reflecting material 12. Alternatively, the conductive thin film layer 16 may be composed of a plurality of sheets of the radio wave reflecting material 12. In this case, the plurality of the radio wave reflecting materials 12 are arranged at predetermined intervals on substantially the entire upper surface of the substrate layer 13. The shape of the radio wave reflecting material 12 may be a circle, a rectangle, a triangle, a polygon, or the like.

### Another Embodiment

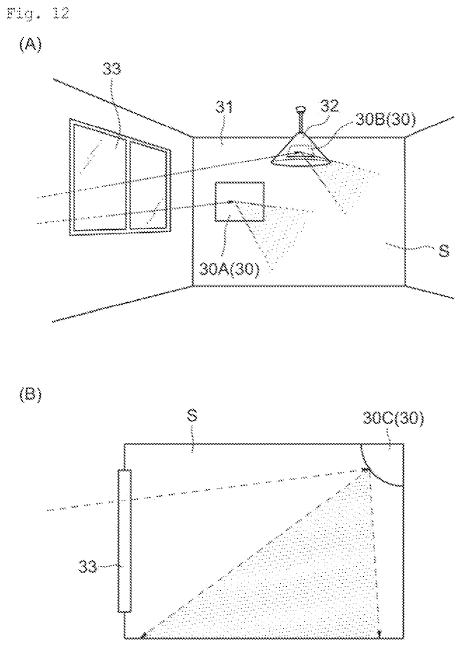

In another embodiment of the structure 10, which is the radio wave reflector 11, the radio wave reflecting material 12 may be dispersed in the substrate layer 13 formed of a synthetic resin material, as shown in FIG. 11, instead of being formed on the upper surface of the substrate layer 13. In this embodiment as well, the reflection intensity can be kept high within the wide angle range a of ±15 degrees with respect to the reflection direction of specularly reflected radio waves. Further, the radio wave reflector 11 is not limited to one having a metamaterial structure, and may be, for example, any of a metallic nanowire lamination film, multilayer graphene, or partially exfoliated graphite.

In the embodiment in which the radio wave reflecting material 12 is dispersed in the substrate layer 13 formed of a synthetic resin material, the radio wave reflecting material 12 may be in the form of particles, scales, rods, or fibrous. In the form of particles, the particle size of the radio wave reflecting material 12 is not particularly limited, and the average particle size is preferably 0.01 μm or more and 0.8 μm or less.

A scale-like shape refers to a flaky shape formed by pushing and crushing a three-dimensional shape, such as a spherical or lumpy shape, in one direction. The shape includes, for example, a plate-like shape and is also referred to as a flake-like shape. The size of the radio wave reflecting material 12 in the form of scales is not particularly limited. The maximum length of a straight line passing through two different points on the outer peripheral edge and the center of gravity in plan view is preferably 0.4 μm or more and 0.8 μm or less, the minimum length of the same straight line is preferably 0.4 μm or more and 0.6 μm or less, the thickness is preferably 0.01 μm or more and 0.20 μm or less, and the aspect ratio is preferably 1 or more and or less.

A rod-like shape refers to a bar-like shape elongated in the axial direction. The cross-sectional shape of the bar is not particularly limited and may be, for example, a rectangle, a circle, an ellipse, or a polygon. Further, the cross-sectional shape of the bar may vary along the axial direction and includes a cone-like shape, tree-like shape, needle-like shape, and other shapes. The length in the axial direction is preferably 0.4 μm or more and 0.8 μm or less, the maximum length of a straight line passing through two different points on the outer peripheral edge and the center of gravity in the cross-section at any location in the axial direction is preferably 0.01 μm or more and 0.8 μm or less, and the aspect ratio is preferably 1 or more and 1000 or less.

A fibrous shape refers to an elongated thread-like shape, and the length in the length direction is preferably 0.8 μm or more and 2000 μm or less, the diameter is preferably 0.01 μm or more and 0.8 μm or less, and the aspect ratio is preferably 100 or more and 1,000,000 or less.

The relative permittivity at a frequency of 10 GHz in the radio wave reflecting material 12 dispersed in the substrate layer 13 is preferably 1.0×10⁴ or more and 1.0×10⁸ or less. The material of the radio wave reflecting material 12 dispersed in the substrate layer 13 is not particularly limited as long as it has a shape and relative permittivity as described above, and may be a metal, an alloy, or a metal compound. Preferred are gold, silver, platinum, nickel, aluminum, indium tin oxide, an alloy thereof, and the like; and more preferred are gold, silver, platinum, nickel, and aluminum.

The content of the particles in the substrate layer 13 is preferably 10 parts by weight or more and 4000 parts by weight or less, more preferably 20 parts by weight or more and 2000 parts by weight or less, and still more preferably 25 parts by weight or more and 1900 parts by weight or less, based on 100 parts by weight of the content of the synthetic resin material of the substrate layer 13.

The preferred range, calculation formula, and measurement method for the developed interfacial area ratio Sdr are the same as those in the embodiment shown in FIGS. 2 and 3. In this embodiment, the height at multiple points on the surface of the substrate layer 13, i.e., the radio wave reflector 11, is measured; and from the measurement values, the developed interfacial area ratios Sdr are each calculated. Thereafter, the arithmetic mean value is calculated to determine the developed interfacial area ratio Sdr. In this embodiment, since the radio wave reflecting material 12, which is the conductive thin film layer 16, is dispersed in the substrate layer 13, the developed interfacial area ratio Sdr of the conductive thin film layer 16 is calculated using the height of the substrate 13.

Other configurations and functions are the same as those in the embodiment shown in FIGS. 2 and 3, and the same reference numerals are used to refer to corresponding configurations to omit the detailed descriptions thereof.

### Use

The structure 10 comprising any of the radio wave reflectors 11 described above may be included in a building material 30 and used. Examples of the building material 30 include, as shown in FIG. 12(A), materials that can be installed in a building as a decorative material 30A, such as wallpapers for wall surfaces, ceiling surfaces, and floor surfaces of rooms and corridors, wallpapers for partitions, and posters, or as a decorative material 30B, such as transparent stickers for light covers. By attaching decorative materials 30A, 30B including the structure 10 to a wall surface 31 and a light cover 32, radio waves entering the room from the outside through a window 33 or the like are reflected by the decorative materials 30A, 30B provided on the wall surface 31 and the light cover 32. As a result, radio waves reach a wider area of the indoor space S, thus increasing the convenience of radio wave reception.

Alternatively, the structure 10 may be formed to be present inside a member or a building material comprising a non-conductive material such as resin. For example, the wall surface 31 itself or the lamp cover 32 itself, which are building materials 30, may comprise a radio wave reflector 11. Further, the building material 30 is not limited to indoor walls and light covers, and may be, for example, partitions, pillars, lintels, outer walls of buildings, windows, and the like. For example, FIG. 12(B) is a plan view of the interior of a room. The building material 30 that is a radio wave reflector 11 is formed as a corner post 30C that has a curved surface at the corner of the room. Radio waves entering from a window 33 are reflected by the corner post 30C and thus reach a wider range of the indoor space S. FIGS. 12(A) and 12(B) show an application example of the building material 30 and are not intended to show the actual range of radio wave reflection.

### Evaluation Test

Examples 1 to 8 were produced as structures 10 that are radio wave reflectors 11. Examples 1 to 8 and Comparative Examples 1 to 3 were tested and evaluated for angular practicality, scenery visibility, and installability. However, the structure of the present invention is not limited to Examples 1 to 8.

### Explanation of Examples and Comparative Examples

The structure 10 produced as Example 1 is a structure that has the same configuration as that of the embodiment shown in FIGS. 2 and 3. As the substrate layer 13, a synthetic resin material sheet formed of PET (Lumirror 50T60, produced by Toray Industries, Inc.) was used. The substrate layer 13 was set to a thickness of 50 μm and a one-side length of 620.5 mm. The radio wave reflecting material 12 was a metal thin film formed of silver (Ag). The radio wave reflecting material 12 was set to a thickness (film thickness) L3 of 50 nm and a one-side length L1 of 77.460 mm, and the interval L2 between adjacent radio wave reflecting materials 12 was set to 100 μm (tolerance ±10 μm). The radio wave reflecting material 12 had a developed interfacial area ratio Sdr of 30%, a surface resistance value of 8.7Ω/□, and a coverage of 99.7%. As the adhesive layer 14, an optical adhesive silicon adhesive sheet (ISR-SOC, 150μ type, produced by Iwatani Corporation) was used. The adhesion layer 14 had a dielectric loss tangent of 0.04, which is higher than 0.018. As the protective layer 15, a synthetic resin sheet formed of PET (Lumirror 50T60, produced by Toray Industries, Inc.) was used. The protective layer 15 was set to a thickness of 50 μm. The structure 10 had a total light transmittance of 82%.

A method for producing the structure 10 of Example 1 is described. First, the radio wave reflecting material 12 is formed on a substrate layer 13. In the production of Example 1, a roll-to-roll sputtering apparatus is used. A target including a metal (for example, silver) is attached to a cathode provided in a film-forming chamber of the sputtering apparatus. A ground shield with a size such that 5% of the cathode is concealed is provided on the cathode. The film-forming chamber of the sputtering apparatus is evacuated by a vacuum pump to reduce the pressure to, for example, 3.0×10⁻⁴ Pa and, for example, argon gas is supplied at a predetermined flow rate (100 sccm). In this state, the substrate layer 13 is conveyed to a position under the cathode, for example, at a conveying speed of 0.1 m/min and a tension of 100 N. A pulsed power of 5 kW is supplied from a bipolar power supply connected to the cathode, whereby metal is ejected from the target and deposited on the surface of the substrate layer 13, thus forming a metal thin film.

Whether or not the metal thin film is formed with a desired thickness is evaluated, for example, by the following procedure. Indentations that penetrate the metal thin film at predetermined locations (about 30 locations in this embodiment) are formed, for example, using a nanoindenter (TI950, produced by Hysitron Inc.). Using a laser microscope (VK-X1000/1050, produced by Keyence Corporation), the thickness of the metal thin film is measured from the gap created by each indentation. The average film thickness and standard deviation are obtained from the measurement values obtained at about 30 locations. Whether or not the average film thickness is the desired thickness L3 (for example, 50 nm), and whether or not the variation in the measurement values is within the desired range (for example, the standard deviation is within 5) are evaluated.

Next, the metal thin film is divided. Using a stainless steel needle with a round tip and a tip outer diameter of 80 μm, the metal thin film is linearly scraped off vertically and horizontally at predetermined intervals to divide the film into a plurality of squares. A plurality of radio wave reflecting materials 12 are thereby formed on the substrate layer 13.

A protective layer 15 is then attached to the radio wave reflecting material 12 by an adhesive layer 14. Using an adhesive layer 14, the protective layer 15 is attached onto the radio wave reflecting material 12 of the substrate layer 13 so as not to allow air bubbles to enter. The structure 10 that is a radio wave reflector 11 is thereby produced.

The structure 10 produced as Example 2 is different from Example 1 in the conductive thin film layer 16, the adhesive layer 14, and the protective layer 15. In Example 2, the radio wave reflecting material 12 of the conductive thin film layer 16 had a developed interfacial area ratio Sdr of 27%, a surface resistance value of 8.7Ω/□, and a coverage of 99.7%. As the adhesive layer 14, a rubber adhesive described below was used. Specifically, 100 parts by weight of a rubber polymer (a mixture of 50 mass % of a styrene-(ethylene-propylene)-styrene block copolymer and 50 mass % of a styrene-(ethylene-propylene) block copolymer, styrene content: 15%, weight average molecular weight: 130000), 40 parts by weight of a synthetic resin (FMR-0150, produced by Mitsui Chemicals), 20 parts by weight of a softening agent (LV-100, produced by JX Nippon Oil & Energy Corporation), 0.5 parts by weight of an antioxidant (Adekastab AO-330, produced by ADEKA Co., Ltd.), and 150 parts by weight of toluene were placed in a reaction vessel equipped with a cooling tube, a nitrogen inlet tube, a thermometer, a dropping funnel, and a stirrer and stirred at 40° C. for 5 hours. The resulting mixture was applied to the protective layer 15 and dried. As the protective layer 15, a synthetic resin sheet formed of COP (ZeonorFilm ZF14, produced by Zeon Corporation) was used. The protective layer 15 was set to a thickness of 50 μm. The adhesive layer 14 and the protective layer 15 in Example 2 had a dielectric loss tangent of 0.002, which satisfies a range of 0.018 or less. This dielectric loss tangent value is lower than that of the optical adhesive silicon adhesive sheet used as the adhesive layer 14 of Example 1. The structure 10 had a total light transmittance of 82%. Other configurations were the same as those of Example 1.

The structure 10 produced as Example 3 had the same configuration as that of the embodiment shown in FIG. 9. The adhesive layer 14 and protective layer 15 used in Example 3 were the same as those in Example 2. The radio wave reflecting materials 12A, 12B of the conductive thin film layer 16 each had a developed interfacial area ratio Sdr of 60%, a surface resistance value of 8.7Ω/□, and a coverage of 99.7%. The structure 10 had a total light transmittance of 80%. Other configurations were the same as those of Example 1.

The structure 10 produced as Example 4 had the same configuration as that of the embodiment shown in FIGS. 4 and 5. The radio wave reflecting material 12 was set to a one-side length L1 of 7.7460 mm. The radio wave reflecting material 12 of the conductive thin film layer 16 had a developed interfacial area ratio Sdr of 21%, a surface resistance value of 8.6Ω/□, and a coverage of 97.4%. The structure 10 had a total light transmittance of 82%. Other configurations of the radio wave reflecting material 12, the substrate layer 13, the adhesive layer 14, and the protective layer 15 were the same as those of Example 1.

The structure 10 produced as Example 5 is a structure having the same configuration as that of the embodiment shown in FIGS. 6 and 7. The radio wave reflector 11, which is structure 10, had a square shape in plan view. The radio wave reflector 11 was set to a one-side length L10 of 20 cm and a thickness L11 of 0.25 mm. The structure 10 had a total light transmittance of 85%. Using a synthetic resin material formed of PET (Lumirror 50T60, produced by Toray Industries, Inc.) as the substrate layer 13, the thickness L8 of the substrate layer 13 was set to 50 μm. The radio wave reflecting material 12 of the conductive thin film layer 16 was a linear metal thin film formed of silver (Ag). The radio wave reflecting material 12 was set to a thickness (film thickness) L3 of 0.5 μm (500 nm) and a line width L6 of 0.5 μm (500 nm), and the length L7 between adjacent radio wave reflecting materials 12 was set to 60 μm. The radio wave reflecting material 12 had a surface resistance value of 1.7Ω/□ and a coverage of 7%. The radio wave reflecting material had a developed interfacial area ratio Sdr of 10%. As the adhesive layer 14, the same rubber adhesive as used in Example 2 was used. The adhesive layer 14 was set to a thickness L4 of 150 μm. The adhesive layer 14 had a dielectric loss tangent of 0.04. As the protective layer 15, a synthetic resin sheet formed of PET (Lumirror 50T60, produced by Toray Industries, Inc.) was used. The protective layer 15 was set to a thickness L5 of 50 μm.

A method for producing the radio wave reflector 11 of Example 5 is described. First, the radio wave reflecting material 12 is formed on a substrate layer 13. A core layer of 0.01 μm or more and 3 μm or less is formed on one surface of a copper foil with a thickness of 5 μm or more and 200 μm or less, which has sufficient strength as a metal layer, by a method such as electrolytic or electroless plating. A conductive thin film layer 16 having a predetermined arrangement pattern is then formed on the surface of the core layer by a method such as electrolytic or electroless plating. Subsequently, the entire conductive thin film layer 16 is covered with a substrate layer 13. The substrate layer 13 is pre-coated with an adhesive. The copper foil and the core layer are then removed by etching. The radio wave reflecting material 12 is thereby formed on the substrate layer 13.

Using an adhesive layer 14, a protective layer 15 is attached to the radio wave reflecting material 12 on the side opposite to the side where the substrate layer 13 is present. Using the adhesive layer 14, the protective layer 15 is attached to the radio wave reflecting material 12 on the substrate layer 13 so as not to allow air bubbles to enter. The radio wave reflector 11 is thereby produced.

In the structure 10 produced as Example 6, the arrangement pattern of the radio wave reflecting material 12 of the conductive thin film layer 16 is staggered as shown in FIG. 8(A). The radio wave reflecting material 12 had a line width L6 of 0.4 μm (400 nm) and a coverage of 5%. The radio wave reflecting material 12 had a surface roughness Sdr of 3%. The structure 10 had a total light transmittance of 87%. Other configurations were the same as those of Example 5.

In the structure 10 produced as Example 7, the arrangement pattern of the radio wave reflecting material 12 of the conductive thin film layer 16 was the same as that of Example 5. The radio wave reflecting material 12 was set to a thickness (film thickness) L3 of 5 μm, a line width L6 of 0.2 μm (200 nm), and a coverage of 10%. The radio wave reflecting material 12 had a developed interfacial area ratio Sdr of 572%. The structure 10 had a total light transmittance of 90%. Other configurations were the same as those of Example 5.

The structure 10 produced as Example 8 is a structure having the same configuration as that of the embodiment shown in FIG. 11, in which a granular radio wave reflective material 12 is dispersed in the substrate layer 13. The substrate layer 13 had a thickness L8 of 128 μm. The radio wave reflecting material 12 dispersed inside the substrate layer 13 was particles formed of silver and had an average particle diameter of 0.4 μm (400 nm). The particle content was 110 parts by weight per 100 parts by weight of the synthetic resin material content of the substrate layer 13. The developed interfacial area ratio Sdr was 90%. The structure 10 had a total light transmittance of 80%.

As Comparative Example 1, an aluminum plate with a thickness of 3 mm was used. Comparative Example 1 had a developed interfacial area ratio Sdr of 0.3% and a total light transmittance of 0%.

As Comparative Example 2, an aluminum sheet (aluminum foil) having a thickness of 0.012 mm was used. Comparative Example 2 had a developed interfacial area ratio Sdr of 6% and a total light transmittance of 10%.

As Comparative Example 3, an aluminum plate with a thickness of 0.6 mm was used. Comparative Example 2 had a developed interfacial area ratio Sdr of 0.3% and a total light transmittance of 0%.

### Measurement of Reflection Intensity, Calculation of Kurtosis, and Evaluation Indices

The intensity of the reflective waves of Examples 1 to 8 and Comparative Examples 1 to 3 (also collectively referred to as “sample”), which are measurement targets, was measured by the following procedure according to the method for measuring the amount of reflection described in JIS R 1679:2007. A sample was placed on a sample stand. A transmitting antenna and a receiving antenna were disposed according to the radio wave incident angle θ1 and the radio wave reflection angle θ2 (el, 62=30°, 45°, 60°). The distance between the sample and the receiving antenna and the distance between the sample and the transmitting antenna were set to 1 m. Radio waves with frequencies changed from 3 GHz to 300 GHz (4 GHz, 28.5 GHz, 47 GHz, 95 GHz, 144 GHz, 160 GHz, and 300 GHz) were output from the transmitting antenna. The amount of reflection (reflection intensity) of radio waves at each frequency was measured.

First, a reference metal plate (aluminum A1050 plate, thickness: 3 mm) was placed on a sample stand. The reception level was measured and recorded using a scalar network analyzer. In this measurement, coaxial cables of the receiving antenna and the transmitting antenna were directly connected by a scalar network analyzer, and the signal level at each frequency was calibrated as 0. The device was then reconfigured and the measurement was performed. After the reference metal plate was removed from the sample stand, each sample was placed on the sample stand and the reception level was measured and recorded. The amount of reflection in the specular reflection direction of the structure 10 to be measured was obtained by subtracting the reception level of the reference metal plate from the measured reception level. Further, the receiving antenna was moved to angular positions of ±5 degrees, ±10 degrees, and ±15 degrees with respect to the specular reflection direction of radio waves, with the reflection point 11a of the sample being set as the center. The reception level at each reception angular position was measured and recorded. Each sample was measured in the same manner. When the frequency of radio waves was 10 GHz or less, the sample was appropriately irradiated with a plane wave using a millimeter wave lens in consideration of the first Fresnel radius of the rectangular horn antenna used.

The kurtosis of each sample was calculated by the above formula (1) from measurement values of the amount of reflection at each reception angular position.

The angular practicality, scenery visibility, and installability were set as three evaluation indices. The angular practicality is an index for evaluating whether or not reflective waves can be sufficiently received by a receiving antenna within an angle range a of ±15 degrees with respect to the specular reflection direction. The receiving antenna was moved to angular positions of the specular reflection direction (i.e., 0 degrees) and ±5 degrees, ±10 degrees, and ±15 degrees from the specular reflection direction, and the reflection intensity was measured at each reception angular position. In this measurement, when a reflection intensity of −40 dB or more was obtained at all of the reception angular positions, it was evaluated as “A.” When the reflection intensity was less than −40 dB and −45 dB or more at all of the reception angular positions, it was evaluated as “B.” When the reflection intensity was less than −45 dB (less than or equal to the performance of a metal plate that is a conventional radio wave reflecting material (aluminum plate)) at any of the reception angular positions, it was evaluated as “C.” If the evaluation is A or B, it means that sufficient reflection intensity is ensured and reflection waves can be received with a receiving antenna.

The installability is an index for evaluating whether or not the structure 10 can be attached to a curved surface when the structure 10 is to be installed on a building or the like. When a sample could be attached to a curved surface with a curvature radius R of 300 nm, it was evaluated as “A.” When a sample could not be attached, it was evaluated as “B.”

The scenery visibility is an index for evaluating the transparency of the structure 10. For example, when the structure is attached to the wall of a building and if the wall texture is visible, it was evaluated as “A.” If the wall texture is invisible, it was evaluated as “B.”

### Experimental Results

Tables 1 to 4 show experimental results. Table 1 shows the results of specular reflection intensity, kurtosis, and angular practicality achieved when the incident angle of radio waves was set to 30 degrees. In Examples 1 to 6 and 8, the specular reflection intensity of radio waves at frequencies of 4 GHz, 28.5 GHz, 47 GHz, 95 GHz, 144 GHz, 160 GHz, and 300 GHz was −30 dB or more. In Example 7, the specular reflection intensity of radio waves at a frequency of 300 GHz was −30 dB. When the receiving antenna was moved to angular positions of 0 degrees, ±5 degrees, ±10 degrees, and ±15 degrees with respect to the specular reflection direction of radio waves with the reflection point 11a of the sample being set as the center and the reflection intensity was measured at each reception angular position, Examples 1 to 8 all had a kurtosis of −0.4 or less. Further, Examples 1 to 8 all had a reflection intensity of −45 dB or more or −40 dB or more at all the reception angular positions and were evaluated as “A” or “B” in angular practicality. Table 1 further shows the surface roughness Sdr of Examples 1 to 8. In contrast, Comparative Examples 1 and 3 had a specular reflection intensity of radio waves at each frequency of −30 dB or more and a kurtosis of greater than −0.4, and were evaluated as “C” in angular practicality. Comparative Example 2 had a specular reflection intensity of radio waves at each frequency of less than −30 dB and a kurtosis of −0.4 or more, and was evaluated as “C” in angular practicality.

Table 2 shows the results of specular reflection intensity, kurtosis, and angular practicality achieved when the incident angle of radio waves was set to 45 degrees. Examples 1 to 8 all had a specular reflection intensity of radio waves at each frequency of −30 dB or more. Further, when the reflection intensity was measured at each reception angular position described above, Examples 1 to 8 all had a kurtosis of −0.4 or less. Further, Examples 1 to 8 all had a reflection intensity of −45 dB or more or −40 dR or more at all the reception angular positions, and were evaluated as “A” or “B” in angular practicality. In contrast, Comparative Examples 1 and 3 had a specular reflection intensity of radio waves at each frequency of −30 dB or more and a kurtosis of greater than −0.4, and were evaluated as “C” in angular practicality. Comparative Example 2 had a specular reflection intensity of radio waves at each frequency of less than −30 dB and a kurtosis of −0.4 or more, and was evaluated as “C” in angular practicality.

Table 3 shows the results of specular reflection intensity, kurtosis, and angular practicality achieved when the incident angle of radio waves was set to 60 degrees. Examples 1 to 8 all had a specular reflection intensity of radio waves at each frequency described above of −30 dB or more. Further, when the reflection intensity was measured at each reception angular position described above, Examples 1 to 8 all had a kurtosis of −0.4 or less. Further, Examples 1 to 8 all had a reflection intensity of −45 dB or more or −40 dB or more at all the reception angular positions and were evaluated as “A” or “B” in angular practicality, which means that they were evaluated as good. In contrast, Comparative Examples 1 and 3 had a specular reflection intensity of radio waves at each frequency of −30 dB or more and a kurtosis of greater than −0.4, and were evaluated as “C” in angular practicality. Comparative Example 2 had a specular reflection intensity of radio waves at each frequency of less than −30 dB and a kurtosis of −0.4 or more, and was evaluated as “C” in angular practicality.

As shown in Tables 1 to 3, regardless of whether the incident angle of radio waves was any of 30, 45, and 60 degrees, the structures 10 of Examples 1 to 6 and 8 had a specular reflection intensity of radio waves at frequencies of 4 GHz, 28.5 GHz, 47 GHz, 95 GHz, 144 GHz, 160 GHz, and 300 GHz of −30 dB or more, and the structure 10 of Example 7 had a specular reflection intensity of radio waves at a frequency of 300 GHz of −30 dB or more. Further, regardless of whether the incident angle of radio waves was any of 30°, 45°, and 60°, the structures 10 of Examples 1 to 8 had a kurtosis of −0.4 or less when radio waves at frequencies of 4 GHz, 28.5 GHz, 47 GHz, 95 GHz, 144 GHz, 160 GHz, or 300 GHz were each reflected.

The specular reflection intensity, kurtosis, and angular practicability of Examples 1 to 8 are explained using as an example the case in which the incident angle of radio waves is degrees and radio waves have a frequency of 28.5 GHz. In this case, Example 1 had a specular reflection intensity of −24.8 dB, which satisfies a range of −30 dB or less, and had a kurtosis of −1.27, which satisfies a range of −0.4 or less. Example 1 has a specular reflection intensity that is higher than −40.3 dB in Comparative Example 6, a kurtosis that is less than −0.2 in Comparative Example 1, −0.4 in Comparative Example 2, and −0.2 in Comparative Example 3. The evaluation of Example 1 in angular practicality was A, whereas that of Comparative Examples 1 to 3 was C.

Example 2 had a specular reflection intensity of −22.6 dB, which satisfies a range of −30 dB or more, and had a kurtosis of −1.14, which satisfies a range of −0.4 or less. Example 2 comprises an adhesive layer 14 and a protective layer 15 having a dielectric loss tangent lower than that of Example 1. Example 2 had a higher kurtosis than Example 1 but had a high specular reflection intensity and was evaluated as A in angular practicality.

Example 3 had a specular reflection intensity of −20.5 dB, which satisfies a range of −30 dB or more, and a kurtosis of −1.72, which satisfies a range of −0.4 or less. Example 3 comprises a laminate of a plurality of radio wave reflecting materials 12. Example 3 had a higher specular reflection intensity and a lower kurtosis than Example 1. Example 3 was evaluated as A in angular practicality.

In Example 4, the radio wave reflecting material 12 had a one-side length L1 that is shorter than that of Example 1. Example 4 had a specular reflection intensity of −22.1 dB, which satisfies a range of −30 dB or more, and had a kurtosis of −1.19, which satisfies a range of −0.4 or less. Example 4 was evaluated as A in angular practicality.

Example 5 comprises a conductive thin film layer 16 formed of a linear wave reflecting material 12. The radio wave reflecting material 12 was reflected so that the region 12a without the radio wave reflective material 12 is square-shaped, as shown in FIG. 7(B). Example 5 had a specular reflection intensity of −20.1 dB, which satisfies a range of −30 dB or more, and had a kurtosis of −1.01, which satisfies a range of −0.4 or less. Example 5 was evaluated as A in angular practicality.

Example 6 comprises a conductive thin film layer 16 formed of a linear radio wave reflecting material 12 as in Example 5, but the conductive thin film layer 16 has a shape as shown in FIG. 8(A) and has a line width L6 narrower than that of Example 5. Example 6 had a specular reflection intensity of −20.2 dB, which satisfies a range of −30 dB or more, and had a kurtosis of −0.4, which is higher than that of Example 5. Example 6 was evaluated as B in angular practicality.

In Example 7, the conductive thin film layer 16 has a thickness L3 that is 10 times higher than that of Example 5, and has a line width L6 that is smaller than that of Example 5. Example 7 had a specular reflection intensity of −28.3 dB, which satisfies a range of −30 dB or more, and had a kurtosis of −2.5, which satisfies a range of −0.4 or less. Example 7 was evaluated as A in angular practicality.

Example 8 comprises a particulate radio wave reflecting material 12 dispersed in the substrate layer 13. Example 7 had a specular reflection intensity of −24.8 dB, which satisfies a range of −30 dB or more, and had a kurtosis of −4.5, which satisfies a range of −0.4 or less. Example 8 was evaluated as A in angular practicality.

Table 4 shows evaluation results of Examples 1 to 8 and Comparative Examples 1 to 3 in installability and scenery visibility. Examples 1 to 8, which had a total light transmittance of 80% or more and are transparent, were evaluated as A in scenery visibility, whereas Comparative Examples 1 to 3, which had a low total light transmittance and are not transparent, were all evaluated as B in scenery visibility. Further, Examples 1 to 8, which were flexible and could be attached to a curved surface, were evaluated as A in installability, whereas Comparative Examples 1 and 3, which are aluminum plates and were difficult to bend and could not be attached to a curved surface, were evaluated as B.

TABLE 1

| | | | | | | | | | | | Comp. | Comp. | Comp. |
|---|---|---|---|---|---|---|---|---|---|---|---|---|---|
| | | | Exam- | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 | ple 1 | ple 2 | ple 3 |
| 4 | GHz | Specular | −29.2 | −27.6 | −2.5 | −25.1 | −24.1 | −24.1 | −31.4 | −29.1 | −24.1 | −44.3 | −25.1 |
| | | reflection | | | | | | | | | | | |
| | | intensity (dB) | | | | | | | | | | | |
| | | Kurtosis | −1.21 | −1.22 | −1.89 | −1.18 | −0.99 | −0.4 | −2.3 | −4.2 | −0.2 | −0.1 | −0.2 |
| | | Evaluation: | B | B | A | A | B | B | A | A | C | C | C |
| | | angular | | | | | | | | | | | |
| | | practicality | | | | | | | | | | | |
| 28.5 | GHz | Specular | −28.9 | −26.6 | −24.5 | −26.1 | −24.1 | −24.2 | −31.3 | −28.8 | −24.1 | −44.2 | −25.1 |
| | | reflection | | | | | | | | | | | |
| | | intensity (dB) | | | | | | | | | | | |
| | | Kurtosis | −1.27 | −1.15 | −1.86 | −1.19 | −1.01 | −0.4 | −2.5 | −4.4 | −0.3 | −0.4 | −0.2 |
| | | Evaluation: | B | B | A | B | B | B | A | A | C | C | C |
| | | angular | | | | | | | | | | | |
| | | practicality | | | | | | | | | | | |
| 47 | GHz | Specular | −28.7 | −26.5 | −24.5 | −26.1 | −24.4 | −24.2 | −31.4 | −28.7 | −23.8 | −44.1 | −25.3 |
| | | reflection | | | | | | | | | | | |
| | | intensity (dB) | | | | | | | | | | | |
| | | Kurtosis | −1.25 | −1.15 | −1.8 | −1.2 | −1.04 | −0.4 | −2.6 | −4.5 | −0.3 | −0.4 | −0.1 |
| | | Evaluation: | B | B | A | B | B | B | A | A | C | C | C |
| | | angular | | | | | | | | | | | |
| | | practicality | | | | | | | | | | | |
| 95 | GHz | Specular | −28.6 | −26.4 | −23.6 | −25.9 | −23.8 | −24.3 | −31.1 | −28.6 | −23.8 | −44.2 | −24.9 |
| | | reflection | | | | | | | | | | | |
| | | intensity (dB) | | | | | | | | | | | |
| | | Kurtosis | −1.28 | −1.14 | −1.8 | −1.3 | −1.03 | −0.41 | −2.6 | −4.5 | −0.3 | −0.4 | −0.1 |
| | | Evaluation: | B | B | A | B | B | B | A | A | C | C | C |
| | | angular | | | | | | | | | | | |
| | | practicality | | | | | | | | | | | |
| 144 | GHz | Specular | −28 | −26.3 | −23.6 | −25.8 | −23.5 | −2.4 | −31 | −28.6 | −23.7 | −44.1 | −24.9 |
| | | reflection | | | | | | | | | | | |
| | | intensity (dB) | | | | | | | | | | | |
| | | Kurtosis | −1.31 | −1.22 | −1.91 | −1.31 | −1.12 | −0.44 | −2.61 | −4.5 | −0.3 | −0.4 | −0.1 |
| | | Evaluation: | B | B | A | B | B | B | A | A | C | C | C |
| | | angular | | | | | | | | | | | |
| | | practicality | | | | | | | | | | | |
| 160 | GHz | Specular | −26.1 | −26.1 | −23.4 | −25.7 | −23.4 | −23.9 | −31 | −28.6 | −23.7 | −43.8 | −24.9 |
| | | reflection | | | | | | | | | | | |
| | | intensity (dB) | | | | | | | | | | | |
| | | Kurtosis | −1.2 | −1.13 | −1.92 | −1.31 | −1.2 | −0.42 | −2.61 | −4.5 | −0.3 | −0.4 | −0.1 |
| | | Evaluation: | B | B | A | B | B | A | A | A | C | C | C |
| | | angular | | | | | | | | | | | |
| | | practicality | | | | | | | | | | | |
| 300 | GHz | Specular | −25.3 | −25.9 | −23.2 | −25.6 | −23.2 | −23.9 | −30 | −28.5 | −23.6 | −43.1 | −24.8 |
| | | reflection | | | | | | | | | | | |
| | | intensity (dB) | | | | | | | | | | | |
| | | Kurtosis | −1.1 | −1.11 | −1.96 | −1.33 | −1.52 | −0.42 | −2.62 | −4.5 | −0.3 | −0.4 | 0 |
| | | Evaluation: | B | B | A | B | A | A | A | A | C | C | C |
| | | angular | | | | | | | | | | | |
| | | practicality | | | | | | | | | | | |

| | | | | | | | | | | | |
|---|---|---|---|---|---|---|---|---|---|---|---|
| Developed interfacial | 30 | 27 | 60 | 21 | 10 | 3 | 572 | 90 | 0.3 | 6 | 0.3 |
| area ratio Sdr (%) | | | | | | | | | | | |

TABLE 2

| | | | Exam- | Exam- | Exam- | Exam- | Exam- | Exam- | Exam- | Exam- | Comp. | Comp. | Comp. |
|---|---|---|---|---|---|---|---|---|---|---|---|---|---|
| | | | ple 1 | ple 2 | ple 3 | ple 4 | ple 5 | ple 6 | ple 7 | ple 8 | Example 1 | Example 2 | Example 3 |
| 4 | GHz | Specular | −25.2 | −23.6 | −21 | −21.1 | −20 | −20.1 | −28.4 | −25.2 | −20 | −40.3 | −21 |
| | | reflection | | | | | | | | | | | |
| | | intensity (dB) | | | | | | | | | | | |
| | | Kurtosis | −1.18 | −1.13 | −1.65 | −1.18 | −0.99 | −0.4 | −2.3 | −4.6 | −0.2 | −0.1 | −0.2 |
| | | Evaluation: | B | B | A | A | A | B | A | A | C | C | C |
| | | angular | | | | | | | | | | | |
| | | practicality | | | | | | | | | | | |
| 28.5 | GHz | Specular | −24.8 | −22.6 | −20.5 | −22.1 | −20.1 | −20.2 | −28.3 | −24.8 | −20 | −40.2 | −21 |
| | | reflection | | | | | | | | | | | |
| | | intensity (dB) | | | | | | | | | | | |
| | | Kurtosis | −1.27 | −1.14 | −1.72 | −1.19 | −1.01 | −0.4 | −2.5 | −4.5 | −0.3 | −0.4 | −0.2 |
| | | Evaluation: | B | A | A | A | A | B | A | A | C | C | C |
| | | angular | | | | | | | | | | | |
| | | practicality | | | | | | | | | | | |
| 47 | GHz | Specular | −24.7 | −22.6 | −20.1 | −22.1 | −20.4 | −20.1 | −28.4 | −24.7 | −19.8 | −40.2 | −21 |
| | | reflection | | | | | | | | | | | |
| | | intensity (dB) | | | | | | | | | | | |
| | | Kurtosis | −1.25 | −1.15 | −1.77 | −1.2 | −1.04 | −0.4 | −2.6 | −4.5 | −0.3 | −0.4 | −0.1 |
| | | Evaluation: | B | A | A | A | A | B | A | A | C | C | C |
| | | angular | | | | | | | | | | | |
| | | practicality | | | | | | | | | | | |
| 95 | GHz | Specular | −24.6 | −22.4 | −19.6 | −21.9 | −19.8 | −20.1 | −28.1 | −24.6 | −19.8 | −40.3 | −20.9 |
| | | reflection | | | | | | | | | | | |
| | | intensity (dB) | | | | | | | | | | | |
| | | Kurtosis | −1.28 | −1.14 | −1.8 | −1.3 | −1.03 | −0.41 | −2.6 | −4.5 | −0.3 | −0.4 | −0.1 |
| | | Evaluation: | B | A | A | A | A | B | A | A | C | C | C |
| | | angular | | | | | | | | | | | |
| | | practicality | | | | | | | | | | | |
| 144 | GHz | Specular | −24 | −22.3 | −19.4 | −21.8 | −19.5 | −20 | −28 | −24.6 | −19.7 | −40.2 | −20.9 |
| | | reflection | | | | | | | | | | | |
| | | intensity (dB) | | | | | | | | | | | |
| | | Kurtosis | −1.11 | −1.13 | −1.91 | −1.31 | −1.1 | −0.41 | −26.1 | +4.5 | −0.3 | −0.4 | −0.1 |
| | | Evaluation: | B | A | A | A | A | B | A | A | C | C | C |
| | | angular | | | | | | | | | | | |
| | | practicality | | | | | | | | | | | |
| 160 | GHz | Specular | −22.1 | −22.1 | −19.4 | −21.7 | −19.4 | −19.9 | −28 | −24.6 | −19.7 | −40 | −20.9 |
| | | reflection | | | | | | | | | | | |
| | | intensity (dB) | | | | | | | | | | | |
| | | Kurtosis | −1.1 | −1.13 | −1.92 | −1.31 | −1.2 | −0.41 | −2.61 | −4.5 | −0.3 | −0.4 | −0.1 |
| | | Evaluation: | B | A | A | A | A | A | A | A | C | C | C |
| | | angular | | | | | | | | | | | |
| | | practicality | | | | | | | | | | | |
| 300 | GHz | Specular | −21 | −21.9 | −19.2 | −21.6 | −19.2 | −19.9 | −27.5 | −24.5 | −19.6 | −39.8 | −20.8 |
| | | reflection | | | | | | | | | | | |
| | | intensity (dB) | | | | | | | | | | | |
| | | Kurtosis | −1.1 | −1.11 | −1.98 | −1.33 | −1.5 | −0.42 | −2.62 | −4.5 | −0.3 | −0.4 | 0 |
| | | Evaluation: | B | A | A | A | A | A | A | A | C | C | C |
| | | angular | | | | | | | | | | | |
| | | practicality | | | | | | | | | | | |

TABLE 3

| | | | Exam- | Exam- | Exam- | Exam- | Exam- | Exam- | Exam- | Exam- | Comp. | Comp. | Comp. |
|---|---|---|---|---|---|---|---|---|---|---|---|---|---|
| | | | ple 1 | ple 2 | ple 3 | ple 4 | ple 5 | ple 6 | ple 7 | ple 8 | Example 1 | Example 2 | Example 3 |
| 4 | GHz | Specular | −22.2 | −20.6 | −18 | −18.1 | −17 | −17.1 | −25.4 | −22.2 | −17 | −37.8 | −18 |
| | | reflection | | | | | | | | | | | |
| | | intensity (dB) | | | | | | | | | | | |
| | | Kurtosis | −1.18 | −1.15 | −1.68 | −1.19 | −1.01 | −0.4 | −2.33 | −4.6 | 0 | −0.1 | 0.1 |
| | | Evaluation: | A | A | A | A | A | B | A | A | C | C | C |
| | | angular | | | | | | | | | | | |
| | | practicality | | | | | | | | | | | |
| 28.5 | GHz | Specular | −21.8 | −19.6 | −17.6 | −19 | −17.1 | −17.2 | −25.3 | −21.8 | −17 | −37.4 | −18 |
| | | reflection | | | | | | | | | | | |
| | | intensity (dB) | | | | | | | | | | | |
| | | Kurtosis | −1.28 | −1.14 | −1.72 | −1.19 | −1.01 | −0.4 | −2.5 | −4.5 | −0.3 | −0.4 | −0.2 |
| | | Evaluation: | A | A | A | A | A | B | A | A | C | C | C |
| | | angular | | | | | | | | | | | |
| | | practicality | | | | | | | | | | | |
| 47 | GHz | Specular | −21.7 | −19.6 | −17 | −19.1 | −17.4 | −17.1 | −25.4 | −21.7 | −16.8 | −37.2 | −18 |
| | | reflection | | | | | | | | | | | |
| | | intensity (dB) | | | | | | | | | | | |
| | | Kurtosis | −1.25 | −1.15 | −1.77 | −1.2 | −1.07 | −0.4 | −2.6 | +4.5 | −0.3 | −0.4 | −0.1 |
| | | Evaluation: | A | A | A | A | A | B | A | A | C | C | C |
| | | angular | | | | | | | | | | | |
| | | practicality | | | | | | | | | | | |
| 95 | GHz | Specular | −21.6 | −19.4 | −16.6 | −18.9 | −16.8 | −17 | −25.1 | −21.6 | −16.8 | −37.3 | −17.8 |
| | | reflection | | | | | | | | | | | |
| | | intensity (dB) | | | | | | | | | | | |
| | | Kurtosis | −1.28 | −1.14 | −1.82 | −1.35 | −1.03 | −0.4 | −2.67 | −4.5 | −0.3 | −0.4 | −0.1 |
| | | Evaluation: | A | A | A | A | A | B | A | A | C | C | C |
| | | angular | | | | | | | | | | | |
| | | practicality | | | | | | | | | | | |
| 144 | GHz | Specular | −21 | −19.3 | −16.4 | −18.8 | −16.5 | −17 | −25 | −21.6 | −16.7 | −37.2 | −17.9 |
| | | reflection | | | | | | | | | | | |
| | | intensity (dB) | | | | | | | | | | | |
| | | Kurtosis | −1.12 | −1.16 | −1.91 | −1.31 | −1.1 | −0.41 | −2.61 | −4.5 | −0.3 | −0.4 | −0.1 |
| | | Evaluation: | A | A | A | A | A | B | A | A | C | C | C |
| | | angular | | | | | | | | | | | |
| | | practicality | | | | | | | | | | | |
| 160 | GHz | Specular | −19.1 | −19.1 | −16.4 | −18.7 | −16.4 | −16.9 | −25 | −21.6 | −165 | −37 | −17.9 |
| | | reflection | | | | | | | | | | | |
| | | intensity (dB) | | | | | | | | | | | |
| | | Kurtosis | −1.11 | −1.13 | −1.92 | −1.31 | −1.2 | −0.41 | −2.61 | −4.5 | −0.3 | −0.4 | −0.1 |
| | | Evaluation: | A | A | A | A | A | A | A | A | C | C | C |
| | | angular | | | | | | | | | | | |
| | | practicality | | | | | | | | | | | |
| 300 | GHz | Specular | −18 | −18.9 | −16.1 | −18.6 | −16.2 | −16.8 | −24.5 | −21.5 | −16.4 | −36.8 | −17.8 |
| | | reflection | | | | | | | | | | | |
| | | intensity (dB) | | | | | | | | | | | |
| | | Kurtosis | −1.1 | −1.12 | −2.01 | −1.33 | −1.5 | −0.44 | −2.62 | −4.7 | 0 | 0.1 | 0 |
| | | Evaluation: | A | A | A | A | A | A | A | A | C | C | C |
| | | angular | | | | | | | | | | | |
| | | practicality | | | | | | | | | | | |

TABLE 4

| | | Exam- | Exam- | Exam- | Exam- | Exam- | Exam- | Exam- | Exam- | Comp. | Comp. | Comp. |
|---|---|---|---|---|---|---|---|---|---|---|---|---|
| | | ple 1 | ple 2 | ple 3 | ple 4 | ple 5 | ple 6 | ple 7 | ple 8 | Example 1 | Example 2 | Example 3 |
| Total light transmittance (%) | | 82 | 82 | 80 | 82 | 85 | 87 | 90 | 80 | 0 | 10 | 0 |
| Evaluation | Scenery | A | A | A | A | A | A | A | A | B | B | B |
| items | visibility | | | | | | | | | | | |
| | Installability | A | A | A | A | A | A | A | A | B | A | B |

Embodiments of the present invention have been described above. However, the present invention is not limited to the above-described embodiments. Various modifications are possible without departing from the gist of the present invention. The dimensions, materials, shapes, relative positions, and the like of components described as embodiments or shown in the drawings are not intended to limit the scope of the present invention, but are merely illustrative examples. In the present specification, “parallel” means not only cases where two straight lines, sides, surfaces, etc. do not intersect with each other even if they are extended, but also include cases where two straight lines, sides, surfaces, etc. intersect with each other at an angle of 10° or less.

### REFERENCE SIGNS LIST

10: structure
11: radio wave reflector
11a: reflection point
12, 12A, 12B: radio wave reflecting material
13, 13A, 13B: substrate layer
14, 14A, 14B: adhesive layer
15: protective layer
16: conductive thin film layer
20: radio wave source
21: receiver
30, 30A, 30B, 30C: building material
L1: length of one side of the radio wave reflecting material
L2: interval between adjacent radio wave reflecting materials
L3: thickness of the radio wave reflecting material
L4: thickness of the adhesive layer
L5: thickness of the protective layer
L6: line width of the radio wave reflecting material
L7: length of one side of the region without the radio wave reflecting material
L8: thickness of the substrate layer
L10: length of one side of the radio wave reflecting material
L11: thickness of the radio wave reflecting material.

1. A structure comprising a radio wave reflector including a radio wave reflecting material for reflecting radio waves,
wherein
when the radio wave reflector is caused to reflect a radio wave at an incident angle of an incident wave of 15 degrees or more and 75 degrees or less at a frequency of the incident wave of 3 GHz or more and 5 GHz or less, 25 GHz or more and 30 GHz or less, or 150 GHz or more and 300 GHz or less, the intensity of a reflective wave as specular reflection of the incident wave is −30 dB or more relative to the incident wave, and
in a virtual plane including an incident direction of the incident wave and a reflection direction of the reflective wave, when reception angular positions of the reflective wave are varied within an angle range of −15 degrees or more and +15 degrees or less with respect to the specular reflection direction, kurtosis of distribution of intensity of the reflective wave at each of the reception angular positions is −0.4 or less at least at one frequency.

2. The structure according to claim 1, wherein the kurtosis of distribution of intensity of the reflective wave at each of the reception angular positions is −0.4 or less at a frequency of the incident wave in the range of 3 GHz or more and 300 GHz or less.

3. The structure according to claim 1, wherein the radio wave reflector includes at least a conductive thin film layer comprising the radio wave reflecting material, and a substrate layer comprising a substrate for holding the conductive thin film layer.

4. The structure according to claim 3, wherein the conductive thin film layer has a developed interfacial area ratio of 0.05% or more and 600% or less.

5. The structure according to claim 3, wherein the conductive thin film layer has a surface resistance value of 0.3Ω/□ or more and 10Ω/□ or less.

6. The structure according to claim 3, wherein the radio wave reflecting material of the conductive thin film layer is linear and is arranged to surround regions without the radio wave reflecting material.

7. The structure according to claim 6, wherein the radio wave reflecting material has a line width of 0.05 μm or more and 15 μm or less, a thickness of 0.05 μm or more and 10 μm or less, and a coverage of 50% or less.

8. The structure according to claim 3, wherein in the conductive thin film layer, a plurality of the radio wave reflecting materials having a sheet shape are periodically arranged.

9. The structure according to claim 8, wherein in the conductive thin film layer, the shortest distance between the adjacent radio wave reflecting materials is 1 mm or less, and the conductive thin film layer has a thickness of 0.010 μm or more and 0.35 μm or less, and a coverage of 5% or more and 99.9% or less.

10. The structure according to claim 1, wherein the radio wave reflector is transparent.

11. The structure according to claim 1, wherein in the radio wave reflector, the radio wave reflecting material is laminated with a resin.

12. The structure according to claim 1, wherein in the radio wave reflector, the radio wave reflecting material is dispersed in a resin.

13. The structure according to claim 1, wherein in the radio wave reflector, the radio wave reflecting material is held in a sheet shape by a resin.

14. The structure according to claim 1, wherein the radio wave reflector has flexibility.

15. The structure according to claim 1, wherein the radio wave reflector has a thickness of 1 mm or less.

16. The structure according to claim 11, wherein the resin has a dielectric loss tangent of 0.018 or less.

17. The structure according to claim 11, wherein the resin has a relative permittivity that varies according to an electric field.

18. A building material comprising the structure of claim 1.

19. The building material according to claim 18, wherein the structure has flexibility and is for use in a curved surface.

20. A building material comprising a radio wave reflector including a radio wave reflecting material for reflecting radio waves,
wherein
when the radio wave reflector is caused to reflect a radio wave at an incident angle of an incident wave of 15 degrees or more and 75 degrees or less at a frequency of the incident wave of 3 GHz or more and 5 GHz or less, 25 GHz or more and 30 GHz or less, or 150 GHz or more and 300 GHz or less, the intensity of a reflective wave as specular reflection of the incident wave is −30 dB or more relative to the incident wave, and
in a virtual plane including an incident direction of the incident wave and a reflection direction of the reflective wave, when reception angular positions of the reflective wave are varied within an angle range of −15 degrees or more and +15 degrees or less with respect to the specular reflection direction, kurtosis of distribution of intensity of the reflective wave at each of the reception angular positions is −0.4 or less at least at one frequency.
